(19) United States
(12) Patent Application Publication
(10) Pub. No.: US 2011/0284445 A1
(43) Pub. Date: Nov. 24, 2011

(54) DECK MOUNTED SOLAR CHLORINE GENERATOR AND METHOD

(76) Inventor: Richard D. Mercer, Spring, TX (US)

(21) Appl. No.: 13/114,206

(22) Filed: May 24, 2011

Related U.S. Application Data
(63) Continuation-in-part of application No. 29/362,009, filed on May 19, 2010.
(60) Provisional application No. 61/467,287, filed on Mar. 24, 2011.

(51) Int. Cl. C25B 1/26; C02F 1/76

(52) U.S. Cl. 210/190; 210/192

(57) ABSTRACT

A deck mounted chlorine generator is shown that is preferably powered by use of a solar array panel. The cell plate housing can be supported by a plurality of swivel members that are locked into a position that conforms to the edge of a pool. The cell plate housing utilizes flow directing outlets to direct chlorine out of the housing. An opening such as a drawer is provided in the cell plate housing to permit salt to be poured into the housing around the electrodes to increase chlorine output.

This application is a continuation in part application of U.S. Pat. No. 29/362,009, filed May 19, 2011, which is incorporated by reference, and claims benefit of U.S. Provisional Patent No. 61/467,287, filed Mar. 24, 2011, which is incorporated by reference.

### BACKGROUND OF THE INVENTION

1. Field of the Invention

The present invention relates generally to chlorine generators and, more particularly in one embodiment, to a deck mounted solar chlorine generator.

2. Field of the Invention

Bodies of waters such as pools are generally provided with a deck of some type which may be wood, cement, concrete, grass, or many other materials. The deck leads to the pool walls. In the case of an above ground pool, there may be only the pool wall positioned on grass. A pool is herein considered any body of water. Accordingly, the deck leading to the pool wall may be shaped in many different ways making a rigid mounting to the side of the pool difficult to standardize.

An exemplary floating solar chlorine generator is shown in U.S. Pat. No. 6,508,929, to the present inventor, issued Jan. 21, 2003, which is incorporated herein by reference. This patent discloses a salt housing which is operable to produce a high salt concentration salt brine within the salt housing, which may comprise water from a salt water pool and/or higher concentrations due to added salt within a housing that encloses the electrodes. In one embodiment, a plurality of metallic probes are removably positioned within a salt housing. In one embodiment, the metallic probes are preferably not connected to a power source but rather react within the salt brine to produce metallic ions. A channel is provided whereby the metallic ions can flow into the body of water. The number of metallic probes can be controlled to thereby control the amount of metallic ions produced. As well, moveable gates can be utilized to control the flow of metallic ions into the body of water. In a preferred embodiment, a chlorine generator is also provided which comprises a power source, preferably a solar power source, which supplies power to a plurality of cell plates. The powered cell plates react with the salt brine to produce chlorine atoms that are channeled into the body of water with the metallic ions.

Another floating solar chlorine generator is shown in U.S. Pat. No. D559,943, to the present inventor, which is also incorporated herein by reference. The present inventor has other patents representative of chlorine generation which can be readily located by searching his name in the US patent database.

The present application addresses the above indicated issues and other issues of interest to those of skill in the art. Those of skill in the art will appreciate the present invention, which addresses these and other issues.

### SUMMARY OF THE INVENTION

Accordingly, in one possible embodiment of the present invention, a deck mounted solar chlorine generator is shown for use on a deck of a pool. The generator may comprise a cell plate housing with a plurality of electrodes operable to produce chlorine when electricity is applied in the presence of salt water.

A mounting for the cell plate housing is connected to the cell plate housing for rigidly supporting the cell plate housing in the pool. The mounting may comprise a plurality of swivel members linked together which are conformable to a shape of an edge of the deck of the pool, e.g., the shape of the pool wall. After conforming the mounting to provide a good fit to the edge, the plurality of swivel members are lockable in position whereby the mounting is rigid.

The deck mounted solar chlorine generator may comprise an elongate rigid section on either side of the plurality of swivel members.

The plurality of swivel members linked together may comprise a plurality of pins which extend through each of the swivel members. Each swivel member may comprise a receptacle and a head on opposite sides. The head of an adjacent swivel member is positioned within the receptacle of a neighboring swivel member. The plurality of pins extending through the plurality of receptacles and a plurality of heads to hingeably connect the swivel members together.

A plurality of locking screws mounted in the plurality of heads are operable to engage the plurality of pins to prevent rotation thereby locking the plurality of swivel members in a rigid position.

In another embodiment, the cell plate housing may comprise a plurality of electrodes operable to produce chlorine. In this embodiment, the cell plate housing defines an opening in an upper portion of the cell plate housing for receiving dry salt and/or saltwater brine from a salt pool. The cell plate housing and/or salt drawer is shaped to direct the salt received through the cell plate housing to a position around the electrodes.

The cell plate housing may be substantially cylindrical in shape with multiple openings on the sides thereof to permit salt water flow into the cell plate housing.

In one embodiment, the opening is on a top of the substantially cylindrical cell plate housing. In another embodiment, the opening may further comprise a drawer which fits into the opening to receive the salt and the drawer directs the salt to the position around the electrodes.

In another embodiment, a plurality of vents are positioned above the plurality of electrodes to dispense chlorine from cell plate housing in a selected direction utilizing a hydrogen bubble flow produced by reactions at the electrodes.

In one embodiment, the top of the substantially cylindrical cell plate housing comprises the vents. In another embodiment, the housing may define vents on the side thereof.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a locking mounting with cell plate housing positioned in the pool in accord with one possible embodiment of the invention.

FIG. 2 is a front elevational view of the deck mounted solar chlorine generator in accord with one possible embodiment of the invention.

FIG. 3 is a rear elevational view of the deck mounted solar chlorine generator in accord with one possible embodiment of the invention.

FIG. 4 is a side elevational view of the deck mounted solar chlorine generator in accord with one possible embodiment of the invention.

FIG. 5 is a top elevational view of the deck mounted solar chlorine generator in accord with one possible embodiment of the invention.

FIG. 6 is a bottom elevational view of the deck mounted solar chlorine generator in accord with one possible embodiment of the invention.

FIG. 7 is a side elevational view of the deck mounted solar chlorine generator mounted on a pole configuration above ground pool in accord with one possible embodiment of the invention.

FIG. 8 is a perspective view of a deck mounted solar chlorine generator shown connected to a solar panel in accord with one possible embodiment of the invention.

FIG. 9 is a elevational view, partially in section, showing a deck mounted solar chlorine generator with a salt drawer in accord with one possible embodiment of the invention.

FIG. 10 is a front elevational view showing a deck mounted solar chlorine generator with a salt drawer in accord with one possible embodiment of the invention.

### DESCRIPTION OF PRESENTLY PREFERRED EMBODIMENTS

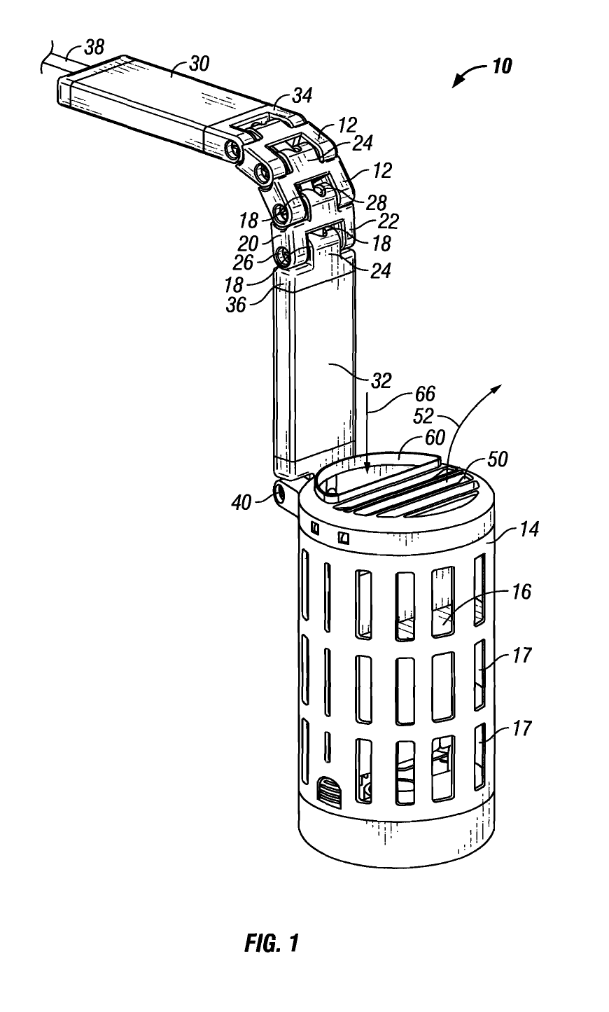

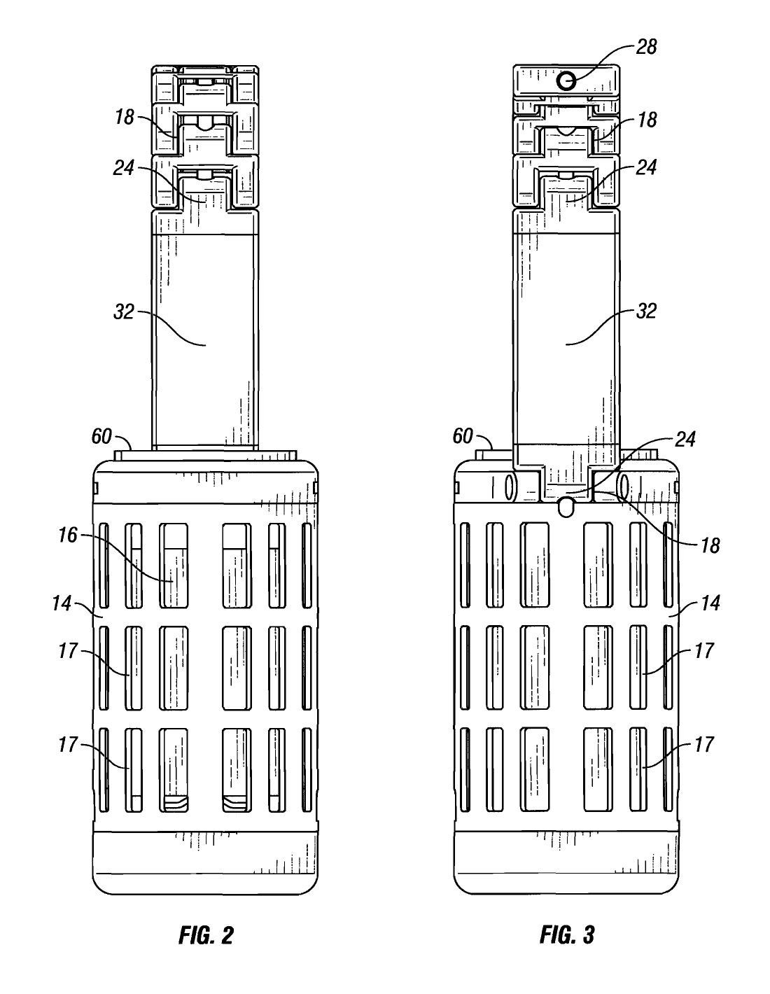

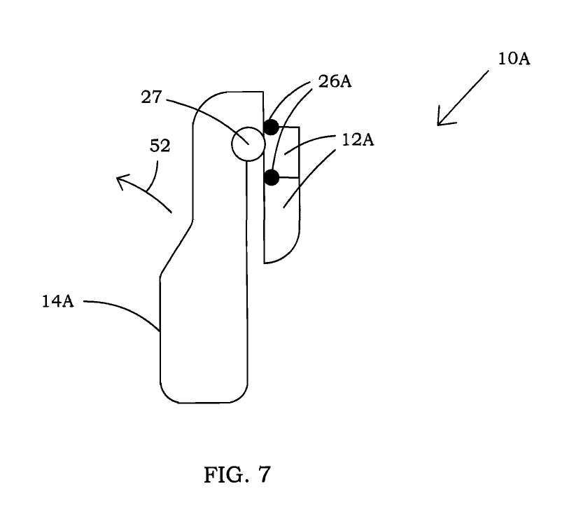

Referring now to the drawings and more particularly to FIG. 1-6, there is shown deck mounted solar chlorine generator system 10 in accord with one possible embodiment of the invention. FIG. 7-10 show another possible embodiment of a deck mounted solar chlorine generator system 10. In a preferred embodiment, solar power is utilized but it will be understood that solar power may be replaced by or supplemented by power from an electrical grid, battery, generator, or the like. Even though the power source changes, the claimed embodiments of the invention could be utilized by using power other than solar. Essentially, the main features of the present invention utilize power from a cable 38 which may be from solar. However, a preferred embodiment of the present system 10 is designed around solar power use.

Cell plate housing 14 comprises a plurality of electrodes 16, which when suspended in salt water and supplied with electricity from the solar panel creates chlorine for the pool along with gas bubbles. Cell plate housing 14 may take various shapes such as a cylinderical shape. Cell plate housing 14 may comprise slots 17 to permit fluid flow of salt water into and out of the housing.

FIGS. 1-6 and 7-10 shown two possible embodiments for adjustable locking sections, which mate to the shape of the coping lip of a pool. These adjustable locking sections may be of various types but as an example, in one presently preferred arrangement, a plurality of swivel members 12 as shown in FIG. 1-6 (or 12A as shown in FIG. 7-10) may be utilized to conform to a shape of an edge of a wall of the pool.

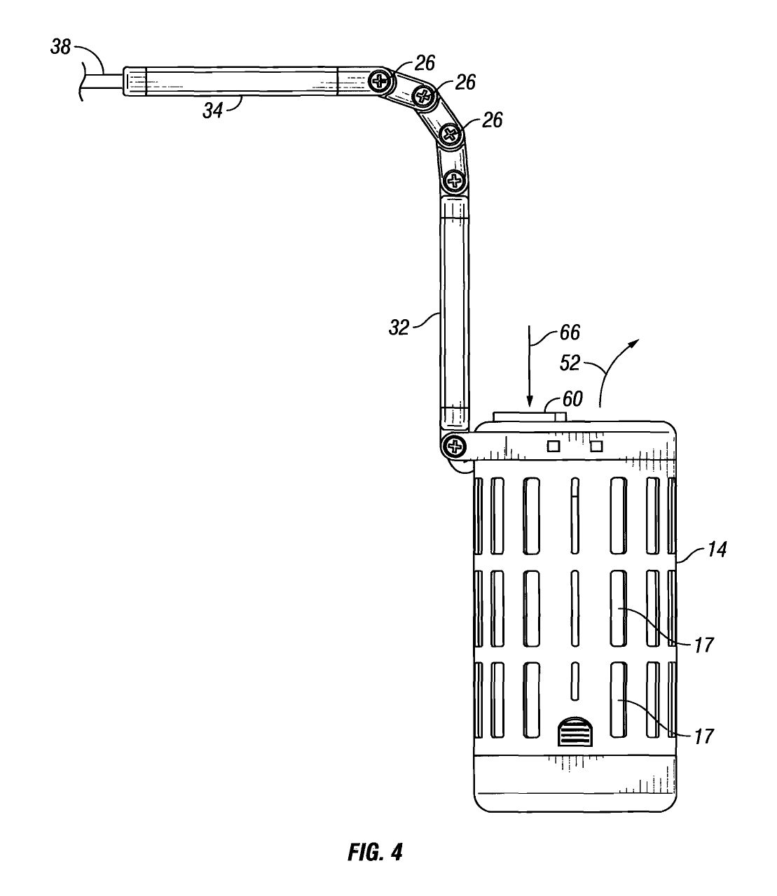

In the swivel members of FIG. 1-6, except for the end most swivel members, each swivel member comprises a receptacle 18 defined within outer prongs 20 and 22. The receptacles 18 receive head elements 24 whereby a head 24 of an adjacent swivel member 12 is positioned within a corresponding receptacle 18 of the neighboring swivel member. A plurality of pins (see e.g. FIG. 4) extend through a plurality of receptacles 18 and a plurality of heads 24, which allows relative pivotal movement of the swivel members.

In this embodiment, the end most swivel members 34 and 36 are essentially broken in half so that one end most swivel member 34 comprises only a receptacle 18 and the other end most swivel member comprises only a head 24. In this embodiment, the end most swivel members 34 and 36 are rigidly mounted to elongate support sections 30 and 32, which are rectangular. The outer material of the swivel members and elongate support sections is preferably plastic, nylon, polymers, elastomers, or otherwise relatively soft material to avoid damage to the wall and/or deck.

In FIG. 7, swivel members 12A are shown mounted on pole or pipe or rim 27 around an above ground pool.

Swivel members 12A of FIG. 7-10 utilize connectors 26A to interconnect the swivel members 12A together. In this case, swivel members may be flat on each side and may comprise hinges or holes through which connectors, such as pins 26, may be run to permit swiveling. A locking mechanism such as screws in the pin, expanding components, contracting components, clamps, and the like may be utilized to lock the swivel members in a particular position or release for conforming to a coping, wall edge, deck edge, or the like.

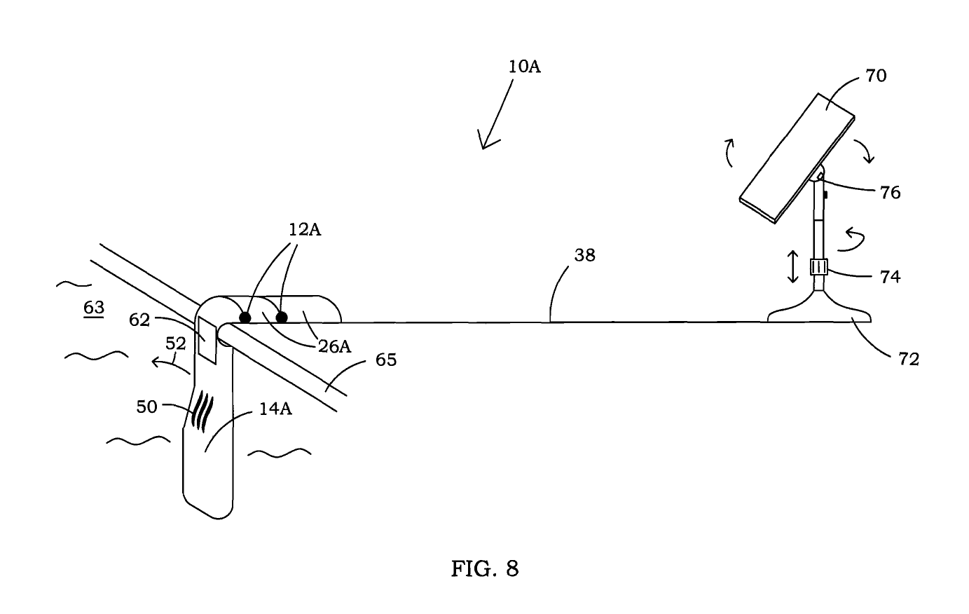

As used herein the deck may be of any type. Grass may form the deck of an above ground pool, with the transition from deck to pool being a wall of the pool. Thus, pool wall, deck wall, coping, edge, and the like are utilized herein substantially interchangeably. Accordingly, the deck may form the edge or pool wall, but the system works in any configuration. Once in the desired position swivel members 12 are locked into place. For example, in FIG. 8, cell plate housing 14A is mounted to edge, coping, top of wall or deck 65 in pool of water 63.

Various means may be utilized to lock the adjustable swivel members into place. For example, pins 26 may comprise screws that tighten the receptacle against the heads, which comprise anti-slip surfaces on the side. In another embodiment, Allen screws 28 or other screws may be utilized to tighten the heads with respect to pins 26. In another embodiment, the adjustable locking clamp formed from swivel members 12 utilize predetermined slots and/or teeth and a push release would lift the latch and allow for the slide fitted adjustment rail to be positioned against the underbelly of the coping lip for a tight secure fit. However, regardless of the actual locking design, the swivel members are locked to provide a rigid mount. The locking mechanisms may comprise latches, cogs, gears, spring loaded latches, clamps, and the like.

On each side of adjustable swivel members 26 elongate support sections 30 and 32 may be utilized with a rubber/soft polymer covers that would help hold position the mounting more securely and not damage the deck, coping, pool wall and the like. Wire 38 (See FIG. 1) from the solar panels or other power source may be coated and protected by elongate support section 30 and/or otherwise covered as desired.

Cell plate housing 14 may be swivel mounted to elongate support section 32 utilizing pin 40. In this example, as best shown in FIG. 3, head 24 from elongates support section 32 fits into receptacle 18 formed as part of the top of cell plate housing 14. Locking members, such as screws, clamps, spring-loaded latches and cogs, and the like, may be utilized to lock the cell plate housing in position, if desired.

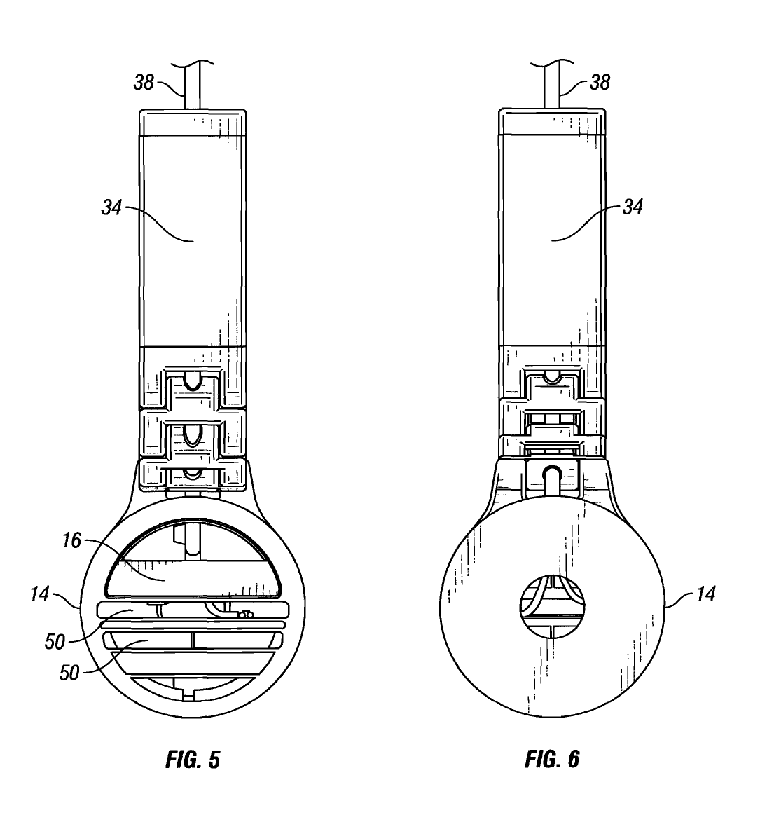

In one possible embodiment, flow directing output ports, in this case vents 50, perhaps best shown in FIG. 1 and FIG. 5, are provided above the cell plates or electrodes 16 in the housing to cause a flow of chlorine out of cell plate housing 14 utilizing a hydrogen bubble stream. Slots, vents, passageways or the like may be utilized as flow directing output ports 50. Cell plate housing 14A shows other types of slots that are used to direct the chlorine out of cell plate housing 14A.

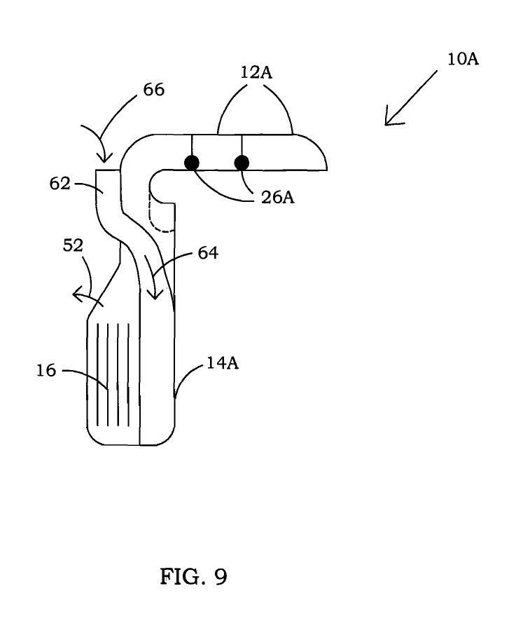

Cell plate housing 14 or cell plate housing 14A (See FIG. 7-9) show the flow directing ports directly above the cell plates. However, if desired the internal shape of the cell plate housing may also be utilized to direct bubble flow and chlorine to a flow directing output port, assuming the port is above and relatively easily reached by bubble flow. If desired, the vents or directing output ports could be adjustable or directable. However, it may be preferred to make them fixed. Bubble flow and chlorine is directed as indicated by flow arrow 52, shown in FIG. 1, FIG. 4, FIG. 7, FIG. 8 and FIG. 9. The direction flow arrow 52 may be directed in a specified way, e.g., away from the housing toward the center of the pool, or may simply be directed outside of cell plate housing 14.

In the embodiments shown in FIGS. 1, 2, 3, 4, and 5, cell plate housing 14 defines opening 60 in the top of cell plate housing 14. Opening 60 allows salt to be poured into the cell plate housing 14 as indicated by arrow 66 in FIG. 4 and FIG. 9, increasing the salinity around cell plates or electrodes 16, to increase the chlorine production. The salt collects at the bottom of cell plate housing 14 and, depending on the type of salt, may take up to a week to dissolve.

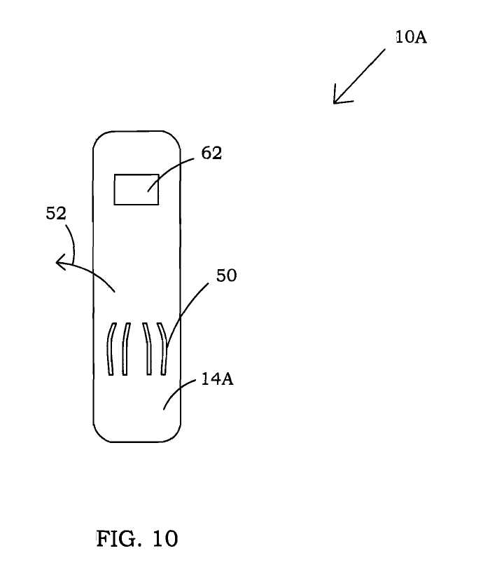

In another embodiment as shown in FIGS. 9 and 10, drawer 62 may be provided in an opening of cell plate housing 14 to insert salt either for boosting or for operation where the salinity of the pool is less than a desired level of salt concentration. In this case, drawer 62 may open and be shaped in a manner that directs salt around electrodes 16 as indicated by arrow 64 after salt is poured into the opening as indicated by arrow 66. If desired, the drawer may then be closed, rotated, or swiveled to a closed position.

Thus, the present system 10 and 10A may work in both salt water pools and fresh water pools. However, if desired, the salinity of the salt may be about 4000 to 6000 ppm which may be approximately typical for a “salt water” pool. The device works fine in this case or at higher salinities, which may be obtained by adding salt to cell plate housing 14 and 14A.

In a preferred embodiment, solar panel array 70 is utilized but the cell plate housing 14 and 14A container may be utilized with other power sources if desired. In this example, solar panel 70 comprises stand 72, telescoping adjustable height and rotation 74, and adjustable pivot 76 which allows orientation of the solar panel array 70 as desired. Wire 38 may be covered with a flat covering or the like as desired and is waterproof.

In operation, swivel members 12 and 12A are unlocked and allowed to conform to the shape of the coping, edge, wall, or the like. Then swivel members 12 and 12A are locked into position providing a rigid mounting.

Salt may be poured into opening 60 and/or drawer 62 to collect around electrodes 16, to greatly increase salinity in that solution or brine whereby the chlorine output is boosted.

Preferably vents utilized as fluid directing ports 50 are positioned to take advantage of bubble flow whereby the chlorine is conveniently directed out of cell plate housing 14. However, flow of chlorine may also proceed through other openings in cell plate housing 14 such as, for example only, slots 17 which essentially surround the housing.

Accordingly, the foregoing disclosure and description of the invention is illustrative and explanatory thereof, and it will be appreciated by those skilled in the art, that various changes in the ordering of steps, ranges, interferences, spacings, and/or attributes and parameters, as well as in the details of the illustrations or combinations of features of the methods and system discussed herein, may be made without departing from the spirit of the invention.

What is claimed is:

1. A deck mounted chlorine generator system for use on a deck of a pool, comprising;
a power source;
a cell plate housing comprising a plurality of electrodes operable to produce chlorine when suspended in salt water and supplied with power from said power source; and
a mounting for said cell plate housing which is connected to said cell plate housing for supporting said cell plate housing in said pool, said mounting comprising a plurality of swivel members linked together which conform to a shape of an edge of said deck of said pool, said plurality of swivel members being lockable in position.

2. The system of claim 1, wherein said power source comprises a solar array operable for mounting on a deck of a pool.

3. The system of claim 1, comprising:
an elongate rigid section on either side of said plurality of swivel members.

4. The system of claim 1, wherein said plurality of swivel members linked together comprise a plurality of pins which extend through each of said swivel members, each swivel member comprising a receptacle and a head, whereby said head of an adjacent swivel member is positioned within said receptacle of each swivel member, said plurality of pins extending through a plurality of receptacles and a plurality of heads.

5. The system of claim 4, further comprising a plurality of locking members mounted in said plurality of heads, said plurality of locking members being operable to prevent rotation for locking said plurality of swivel members in position.

6. The system of claim 1, further comprising
a plurality of vents positioned above said plurality of electrodes and oriented to dispense chlorine in a selected direction from cell plate housing utilizing a hydrogen bubble flow produced by reactions at said electrodes.

7. The system of claim 1 wherein said cell plate housing defines an opening in an upper portion of said cell plate housing for receiving salt, said cell plate housing being shaped to direct salt received through said cell plate housing to a position around said electrodes.

8. A deck mounted chlorine generator for use on a deck of a pool, comprising:
a power source;
a cell plate housing electrically connected to said power source, said cell plate housing comprising a plurality of electrodes operable to produce chlorine, said cell plate housing defining an opening in an upper portion of said cell plate housing for receiving salt, said cell plate housing being shaped to direct salt received through said cell plate housing to a position around said pluraltiy of electrodes.

9. The system of claim 8, wherein said cell plate housing is substantially cylindrical in shape with multiple openings to permit water flow into said cell plate housing.

10. The system of claim 9, wherein said opening is on a top of said substantially cylindrical cell plate housing.

11. The system of claim 10, wherein a remainder of said top comprises vents which direct bubble flow produced by said electrodes away from said housing, whereby said bubble flow is utilized to dispense chlorine.

12. The system of claim 11, further comprising a drawer which fits into said opening to receive said salt and when closed, said drawer directs said salt to said position around said electrodes.

13. The system of claim 8, a plurality of vents in said cell plate housing positioned directly above said plurality of electrodes to dispense chlorine from cell plate housing utilizing a hydrogen bubble flow produced by reactions at said electrodes.

14. The system of claim 8, further comprising a mounting for said cell plate housing which is connected to said cell plate housing for supporting said cell plate housing in said pool, said mounting comprising a plurality of swivel members linked together which conform to a shape of an edge of said deck of said pool, said plurality of swivel members being lockable in position.

15. A deck mounted solar chlorine generator for use on a deck of a pool, comprising:
a power source;
a cell plate housing electrically connected to said power source, said cell plate housing comprising a plurality of electrodes operable to produce chlorine; and
a plurality of flow directing output ports positioned above said plurality of electrodes to dispense chlorine from cell plate housing along a predetermined path utilizing a hydrogen bubble flow produced by reactions at said electrodes.

16. The system of claim 15, wherein flow directing output ports comprise vents.

17. The system of claim 16, wherein said cell plate housing is substantially cylindrical in shape with multiple openings to permit water flow into said cell plate housing.

18. The system of claim 17, wherein a top of said substantially cylindrical cell plate housing comprises said vents.

19. The system of claim 18, wherein said top of said substantially cylindrical cell plate housing also comprises an opening through which salt can be poured and directed to a position around said electrodes to enhance chlorine production.

20. The system of claim 15, comprising
a mounting for said cell plate housing which is connected to said cell plate housing for supporting said cell plate housing in said pool, said mounting comprising a plurality of swivel members linked together which conform to a shape of an edge of said deck of said pool, said plurality of swivel members being lockable in position.
